(19) United States
(12) Patent Application Publication
(10) Pub. No.: US 2012/0060084 A1
(43) Pub. Date: Mar. 8, 2012

(54) INFORMATION PROCESSING DEVICE, PROGRAM, AND INFORMATION PROCESSING METHOD

(75) Inventor: Katsuyuki Takada, Matsumoto-shi (JP)

(73) Assignee: Seiko Epson Corporation, Shinjuku-ku (JP)

(21) Appl. No.: 13/225,252

(22) Filed: Sep. 2, 2011

(30) Foreign Application Priority Data
Sep. 6, 2010 (JP) 2010-198612

(51) Int. Cl. G06F 17/00

(52) U.S. Cl. 715/234

(57) ABSTRACT

An information processing device is provided. In the information processing device, a clip of an arbitrary area is received in a web page on a browser screen and is registered in a clip list. When an operation of a printing preview screen is instructed from the browser screen, the clip list of the browser screen is registered as the clip list of the printing preview screen, and a printing preview screen on which clip data of the clip list is laid out in a sheet area is operated. When the web page on the browser screen is newly clipped during the operation of the printing preview screen, layout of added clip data is performed synchronizing with the clip list of the browser screen, and the content newly clipped on the browser screen is immediately reflected to the of the sheet area of the printing preview screen.

### BACKGROUND

1. Technical Field

The present invention relates to an information processing device that processes page information displayed on a browser screen, a program for causing a computer to serve as the information processing device, and an information processing method.

2. Related Art

Hitherto, an information processing device has been proposed in which a clipboard is displayed on a clipboard operation window (e.g., see JP-A-08-22383). In the information processing device, the clipboard is stored in a clipboard memory for each page, the content of the first page is displayed on the clipboard operation window, and a line (a page number and a header of the page) of the retained page is displayed on an index window.

Considering a case where an arbitrary area of the page displayed on the browser screen is designated and clipped, and the clipped data (clip data) is printed, a plurality of clip data is received to register them in a list, and the plurality of clip data is laid out in the same sheet area to display them on a preview screen. Generally, it is difficult to edit the laid-out data on the preview screen. For this reason, when a user wants to add new clip data while confirming an empty area of the sheet area, the preview screen is closed temporarily every time to newly designate and clip an area of the page of the browser screen, it is necessary to operate the preview screen again, and thus a troublesome operation is imposed on the user.

### SUMMARY

An advantage of some aspects of the invention is to edit clip data laid out on a layout screen without performing a troublesome operation by an information processing device, a program, and an information processing method.

The information processing device, the program, and the information processing method according to the aspects of the invention include the following configurations.

According to an aspect of the invention, there is provided an information processing device which processes page information displayed on a browser screen, the device including: an area designating unit that designates an arbitrary area of a page displayed on the browser screen; a clip unit that clips the designated area to generate clip information; a clip list registering unit that registers the clip information generated by the clip unit, in a clip list; a layout screen operating unit that operates a layout screen on which the clip information registered in the clip list is laid out when the layout screen is instructed to operate; and a layout screen updating unit that lays out the updated clip information to update the layout screen, when the clip information registered in the clip list is updated during the operation of the layout screen.

In the information processing device according to the aspect of the invention, the arbitrary area of the page displayed on the browser screen is designated, the designated area is clipped to generate clip information, the generated clip information is registered in the clip list, the layout screen on which the clip information registered in the clip list is laid out is operated when the operation of the layout screen is instructed, and the updated clip information is laid out and the layout screen is updated when the clip information registered in the clip list is updated during the operation of the layout screen. Accordingly, the user designates the arbitrary area of the page displayed on the browser screen and operates the layout screen to lay out the clip information, it is possible to lay out and display the clip information on the layout screen, and it is possible to directly reflect the updated clip information to the layout screen by newly designating the arbitrary area of the page. As a result, the user can edit the clip data laid out on the layout screen without performing a troublesome operation.

In the information processing device according to the aspect of the invention, a plurality of browser screens may be operable, one browser screen may be operable as a parent screen, and the layout screen may be operable as a child screen. When the area designated from a browser screen different from a browser screen operating the layout screen among the plurality of operated browser screens is clipped during the operation of the layout screen and the clip information is generated, the clip list registering unit may register the generated clip information in the clip list. With such a configuration, it is possible to further simplify the work of adding the content clipped from the browser screen to the layout screen. In the information processing device according to the aspect of the invention, the clip list registering unit may clear the clip list when all processes of the plurality of operated browser screens are completed during the operation of the layout screen.

The information processing device according to the aspect of the invention may further include a list display unit that displays the clip information registered in the clip list as a thumbnail picture, and a clip information selecting unit that selects arbitrary clip information from the clip information registered in the clip list on the basis of an operation of a user, and the layout screen operating unit and the layout screen updating unit may lay out the clip information selected by the clip information selecting unit from the clip information registered in the clip list and display the clip information on the layout screen. With such a configuration, it is possible to display the layout screen of the selected clip information only by selecting the necessary clip information while confirming the clip list on the thumbnail picture. In the information processing device according to the aspect of the invention, when all processes of the plurality of operated browser screens are completed, the clip list registering unit may clear the selection of the clip information registered in the clip list.

In addition, in the information processing device of the aspect of the invention connected to a printing device, the layout screen may be a printing preview screen. With such a configuration, it is possible to perform printing while confirming the layout result of the clip information on the layout screen.

According to another aspect of the invention, there is provided a recording medium storing a program for causing a computer to function as an information processing device which processes page information displayed on a browser screen, the program including: an area designating module that designates an arbitrary area of a page displayed on the browser screen; a clip module that clips the designated area to generate clip information; a clip list registering module that registers the generated clip information in a clip list; a layout screen operating module that operates a layout screen on which the clip information registered in the clip list is laid out when the layout screen is instructed to operate; and a layout screen updating module that lays out the updated clip information to update the layout screen, when the clip information registered in the clip list is updated during the operation of the layout screen.

The program according to the aspect of the invention is installed in the computer, and the user designates the arbitrary area of the page displayed on the browser screen and operates the layout screen to lay out the clip information. Accordingly, it is possible to lay out and display the clip information on the layout screen, and it is possible to directly reflect the updated clip information to the layout screen by newly designating the arbitrary area of the page. As a result, the user can edit the clip data laid out on the layout screen without performing a troublesome operation. The program may be recorded in a computer readable storage medium (e.g., hard disk, ROM, FD, CD, DVD, etc.), may be transmitted from one computer to the other computer through a transmission medium (communication network such as the Internet or a LAN), and may be transmitted and received in any type.

According to still another aspect of the invention, there is provided an information processing method of processing page information displayed on a browser screen, the method including: designating an arbitrary area of a page displayed on the browser screen; clipping the designated area to generate clip information; registering the generated clip information in a clip list; operating a layout screen on which the clip information registered in the clip list is laid out when the layout screen is instructed to operate; and laying out the updated clip information to update the layout screen, when the clip information registered in the clip list is updated during the operation of the layout screen.

According to the information processing method of the aspect of the invention, the arbitrary area of the page displayed on the browser screen is designated, the designated area is clipped to generate the clip information, the generated clip information is registered in the clip list, the layout screen on which the clip information registered in the clip list is laid out is operated when the operation of the layout screen is instructed, and the updated clip information is laid out to update the layout screen when the clip information registered in the clip list is updated during the operation of the layout screen. Accordingly, the user designates the arbitrary area of the page displayed on the browser screen and operates the layout screen to lay out the clip information, it is possible to display the clip information on the layout screen, and it is possible to directly reflect the updated clip information to the layout screen by newly designating the arbitrary area of the page. As a result, the user can edit the clip data laid out on the layout screen without performing a troublesome operation.

### BRIEF DESCRIPTION OF THE DRAWINGS

The invention will be described with reference to the accompanying drawings, wherein like numbers reference like elements.

FIG. 1 is a diagram illustrating a schematic configuration of an information processing device as an embodiment of the invention.

FIG. 2 is a flowchart illustrating an example of a browser mode setting process.

FIG. 3 is a diagram illustrating an example of a browser screen.

FIG. 4 is a diagram illustrating an example of a browser screen during the clip mode.

FIG. 5 is a flowchart illustrating an example of a clip mode process.

FIG. 6 is a flowchart illustrating an example of a clip list editing process.

FIG. 7 is a flowchart illustrating an example of a preview process.

FIG. 8A to FIG. 8F are diagrams illustrating the first half portion of the layout of the clip data.

FIG. 9A to FIG. 9F are diagrams illustrating the second half portion of the layout of the clip data.

FIG. 10 is a diagram illustrating an example of a printing preview screen.

FIG. 11 is a diagram illustrating updating of the printing preview screen.

FIG. 12 is a diagram illustrating updating of the printing preview screen.

FIG. 13 is a diagram illustrating updating of the printing preview screen.

### DESCRIPTION OF EXEMPLARY EMBODIMENTS

Next, embodiments of the invention will be described with reference to examples.

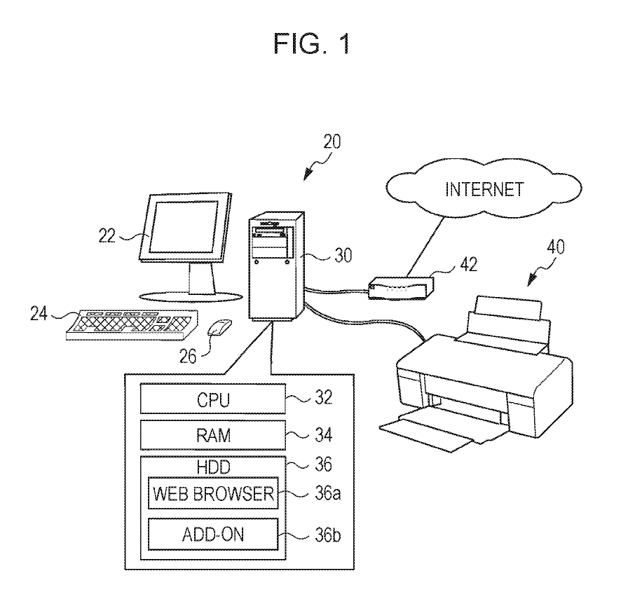

FIG. 1 is a diagram illustrating a schematic configuration of an information processing device 20 as an embodiment of the invention. The information processing device 20 of the embodiment is formed of a general-purpose computer connected to the internet through a router 42, and includes a computer body 30 provided with a CPU 32 as a central operation processing device, a RAM 34 that temporarily stores data, and a hard disk drive device (HDD) 36 that stores process programs, a liquid crystal display 22 as a display device, and a keyboard 24 and a mouse 26 as input devices. The information processing device 20 of the embodiment is connected to a printer 40, and generates and outputs printing data to the printer 40 to print an image.

In the HDD 36 of the computer body 30, various programs such as a web browser 36a for browsing a web page and a clip printing add-on 36b for designating and clipping an arbitrary area of the web page as an expansion function of the web browser 36a or printing the clipped content are installed.

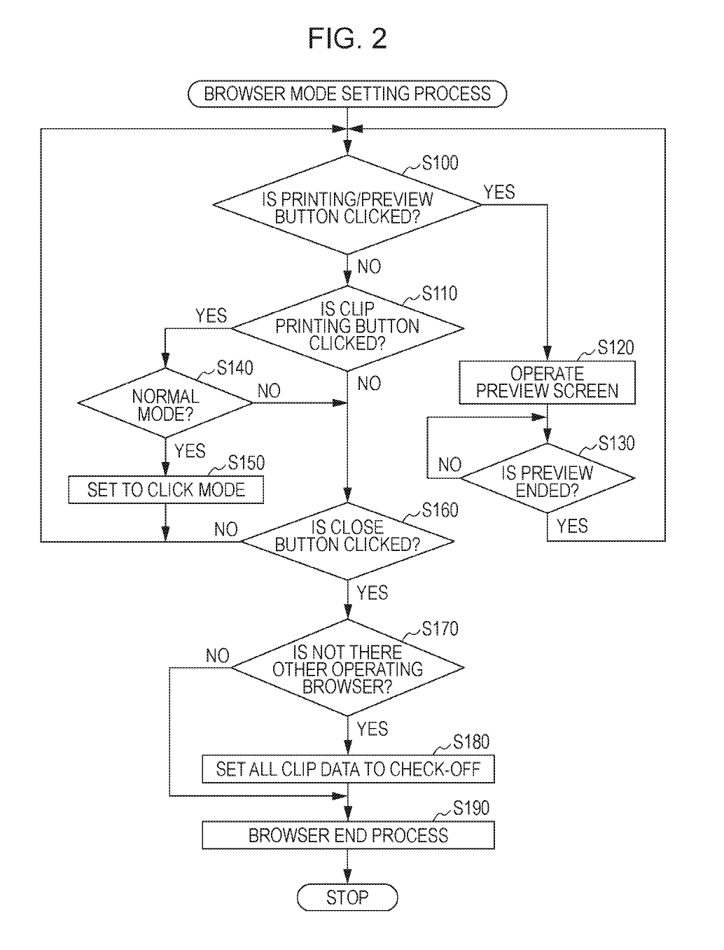

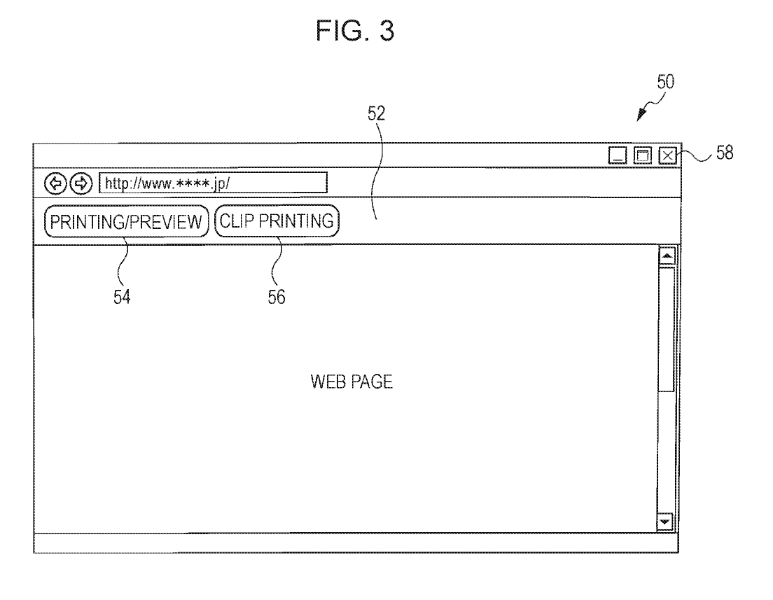

FIG. 2 is a flowchart illustrating an example of a browser mode setting process performed by the CPU 32 of the information processing device 20 of the embodiment. The process is performed when the browser screen is operated. In the embodiment, since the plurality of browser screens can be simultaneously operated, the browser mode setting process is performed for each operated browser screen. FIG. 3 shows an example of a browser screen 50. As shown in FIG. 3, the browser screen 50 is provided with a printing/preview button 54 for previewing and printing the currently displayed web page and a clip printing button 56 for clipping and printing an arbitrary area of the web page, on a toolbar 52 of the upper part. On the right upper side of the browser screen 50, a button 58 for closing the browser screen 50 is provided. The browser screen 50 has a normal mode for browsing the web page and a clip mode for clipping and printing an arbitrary area of the web page, and the normal mode is set just after operating.

When the browser mode setting process is performed, the CPU 32 determines whether the printing/preview button 54 is left-clicked (Step S100) or the clip printing button 56 is left-clicked (Step S110). When the printing/preview button 54 is left-clicked, the printing preview screen for printing the normal web page is operated (Step S120), and it waits in a modal state until the preview is ended (Step S130), and the process returns to Step S100. In addition, the normal printing of the web page does not deviate from the concept of the invention, and thus the description thereof is omitted. When the clip printing button 56 is left-clicked, it is determined whether or not the current mode is the normal mode (Step S140). When the current mode is the normal mode, the clip mode is set (Step S150) and the process returns to Step S100. When the clip mode is set, the browser screen 50 may be changed from the normal mode to the clip mode.

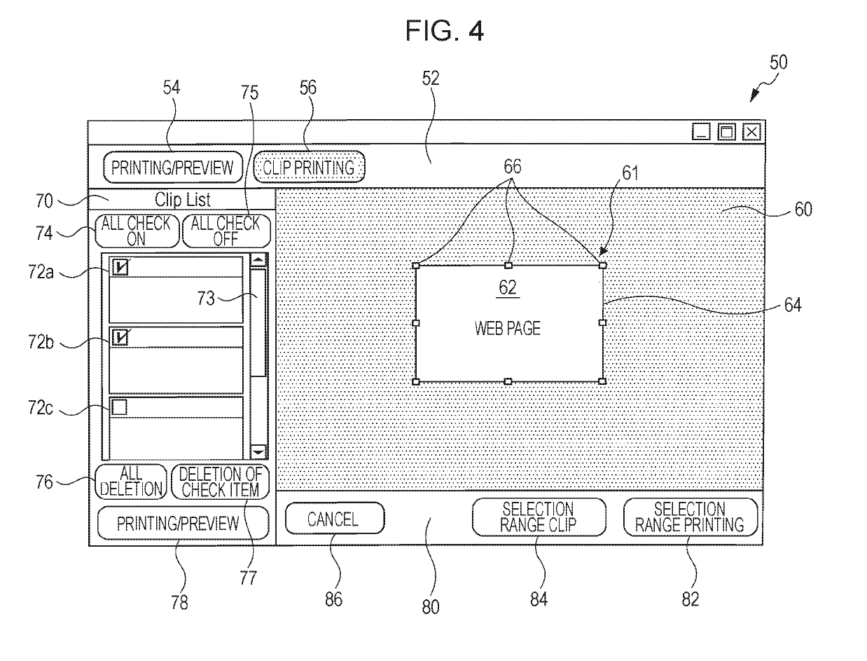

FIG. 4 shows an example of the browser screen 50 during the clip mode. As shown in FIG. 4, on the browser screen 50 during the clip mode, a clip operation area 60 for selecting a clipping area (clip area 62) in the currently displayed web page, a clip list display area 70 for displaying the clip data by thumbnails, and an action bar 80 provided with various buttons for performing various instructions about clip operations are displayed, and the web page display area other than the clip area 62 is covered with a semi-transparent film representing the clip mode. The various buttons provided in the action bar 80 is provided with a selection range printing button 82 of clipping the content in the clip area 62 and registering the content in the clip list and of operating the printing preview screen for printing the clipped content, a selection range clip button 84 of clipping the selected area in the clip area 62 and registering the area in the clip list, and a cancel button 86 of ending the clip mode and returning to the normal browser screen. The clip of the web page is performed by selecting the clip area 62 by a clip band 61 in the clip work area 60 and performing left-clicking with a cursor put to any of the selection range printing button 82 and the selection range clip button 84 by the mouse 26. In addition, the clip band 61 includes a clip frame 64 surrounding the clip area 62 from the outside, and eight clip handles 66 provided at four corners of the clip frame 64 and the centers of the sides thereof, and may be resized by performing the drag operation of the left click with the mouse cursor put on the clip handle 66. The position of the clip band 61 may be moved by performing the drag operation of the left click with the mouse cursor put in the clip area 62. In the clip list display area 70, thumbnail images 72a to 72c obtained by forming the clip data registered in the clip list into thumbnails, and various buttons 74 to 78 for performing various operations on the clip data are displayed. On the right side of the thumbnail images 72a to 72c, a scroll bar 73 for displaying the thumbnail images which cannot be completely displayed in the clip list display area 70 by longitudinal scroll is provided. Check boxes provided on the left upper side of the thumbnail images 72a to 72c are provided to select printing clip data or deleting clip data. When the check box is left-clicked with the cursor by the mouse 26 in a check-off state, the check is turned on. When the check box is left-clicked with the cursor by the mouse 26 in the check-on state, the check is turned off. As the various buttons provided in the clip display area 70, an all-check-on button 74 of checking-on the check boxes of all the clip data in the clip list, an all-check-off button 75 of checking-off the check boxes of all the clip data in the clip list, an all-deletion button 76 of deleting all the clip data in the clip list, a check item deletion button 77 of deleting only the clip data with the check box turned on of the clip data in the clip list, and a printing/preview button 78 of laying out and printing only the clip data with the check box turned on of the clip data in the clip list, in the sheet area are provided.

When it is determined that both of the printing/preview button 54 and the clip printing button 56 are not left-clicked in Steps S100 and S110 or it is determined that the clip printing button 56 is left-clicked in Step S110 but it is determined that the current mode is the clip mode in Step S140, it is determined whether or not the close button 58 is left clicked (Step S160). When the close button 58 is not left-clicked, the process returns to Step S100. Meanwhile, when the close button 58 is left-clicked, it is determined whether or not there is the other operating browser screen (Step S170). When there is no other operating browser screen, the browser screen 50 is ended in the state where the clip data in the clip list is stored (Step S190), and the process is ended. Meanwhile, when there is another operating browser screen, all the clip data in the clip list is set to the check-off (Step S180), the browser screen 50 is ended in the state where the clip data in the clip list is stored (Step S190), and the process is ended. The setting to the check-off of the check state of all the clip data in the clip list when the last browser screen is ended is because it is conceivable that the clip printing is completed in such a situation and thus the setting of the check-on is released for the printing-completed clip data. Of course, it is satisfactory that the setting of the check-on is released for the printing-completed clip data, and thus the check state of the clip data may be set to the check-off at the timing of performing the printing.

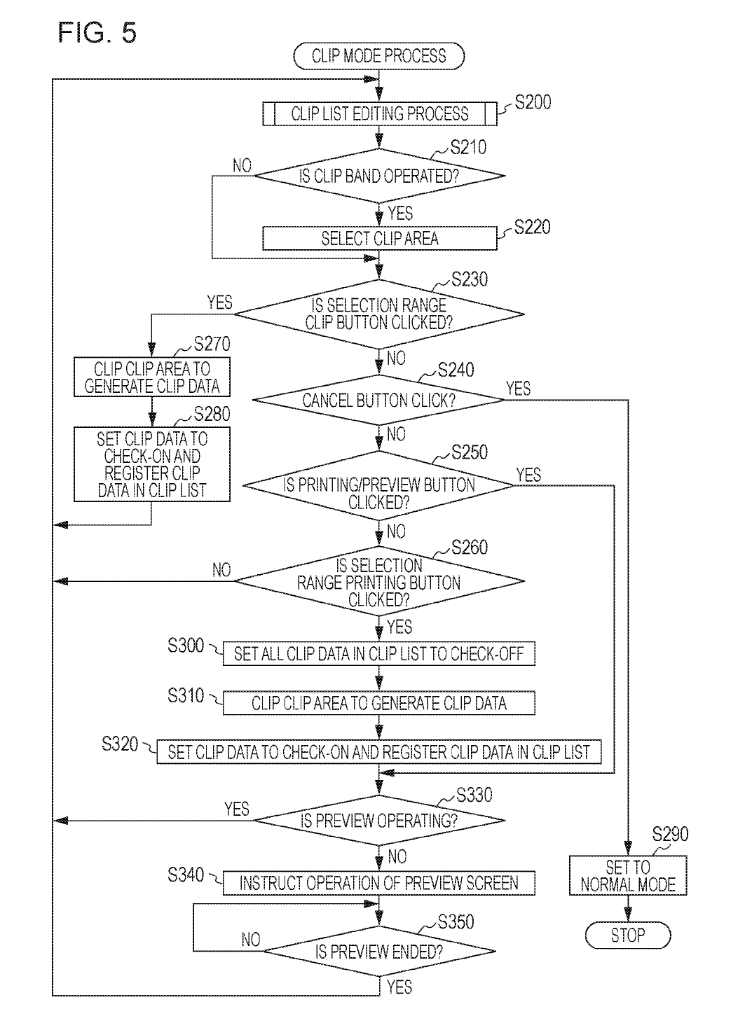

Next, the clip mode process will be described. FIG. 5 is a flowchart illustrating an example of the clip mode process performed by the CPU 32 of the information processing device 20 of the embodiment. The process is performed when the clip mode is set in Step S160 of the browser mode setting process shown in FIG. 2. In addition, the browser mode setting process described above is performed for every operated browser screen, and thus the clip mode process is also performed for every operated browser screen.

When the clip mode process is performed, the CPU 32 first performs a clip list editing process to be described later (Step S200). When the clip list editing process is performed, it is determined whether an operation of the clip band, that is, a drag operation of the left click is performed on the clip handle 66 described above or a drag operation of the left click is performed on the clip area 62 (Step S210). When such an operation is performed, the clip band 61 is resized or moved according to the types of operations (Step S220). When the operation of the clip band is not performed, the process proceeds to the next process.

Subsequently, it is determined whether or not the selection range clip button 84 is left-clicked (Step S230), whether or not the cancel button 86 is left-clicked (Step S240), whether or not the printing/preview button 78 is left-clicked (Step S250), and whether or not the selection range printing button 82 is left-clicked (Step S260). When any button of the various buttons 84, 86, 78, and 82 is not left-clicked, the process returns to Step S200. Meanwhile, when the selection range clip button 84 is left-clicked, the content in the clip area 62 surrounded with the clip band 61 is clipped to generate the clip data (Step S270), the generated clip data is set to the check-on and then is registered in the clip list (Step S280), and the process returns to Step S200. Herein, the registration of the clip list is performed by associating and storing a clip ID (a title of a website or the like) as identification information for identifying the clip data, an URL (Uniform Resource Locator) of the clipped web page, the content of the clipped area, and a check state (check-on and check-off). When the clip data is registered in the clip list, the thumbnail image of the clipped area is added to the clip list display area 70. When the cancel button 86 is left-clicked, the mode is changed from the clip mode to the normal mode, the process returns to the normal browser screen 50 (Step S290), and the process is ended. When the printing/preview button 78 is left-clicked, it is determined whether or not the printing preview screen is already operated (Step S330). When the printing preview screen is not operated, the operation of the printing preview screen is instructed (Step S340), it waits in the modal state until the printing preview screen is ended (Step S350), and the process returns to Step S200. Meanwhile, when the printing preview screen is operated, the process returns to Step S200 to avoid the duplicated operation without instructing the operation of the printing preview screen. When the selection range printing button 82 is left-clicked, all the clip data in the clip list is set to the check-off (Step S300), the content in the clip area 62 surrounded with the clip band 61 is clipped to generate the clip data (Step S310), and the generated clip data is set to the check-on and then registered in the clip list (Step S320). Then, it is determined whether or not the printing preview screen is already operated (Step S330). When the printing preview screen is not operated, the operation of the printing preview screen is instructed (Step S340), it waits in the modal state until the printing preview screen is ended (Step S350), and the process returns to Step S200. Meanwhile, when the printing preview screen is already operated, the process returns to Step S200 without instructing the operation of the printing preview screen. In addition, when the selection range printing button 82 is clipped, only the clip data registered at this time is set to the check-on in the clip list and all the other clip data are set to the check-off. Accordingly, the operation of the printing preview for printing only the clip data registered at this time is instructed.

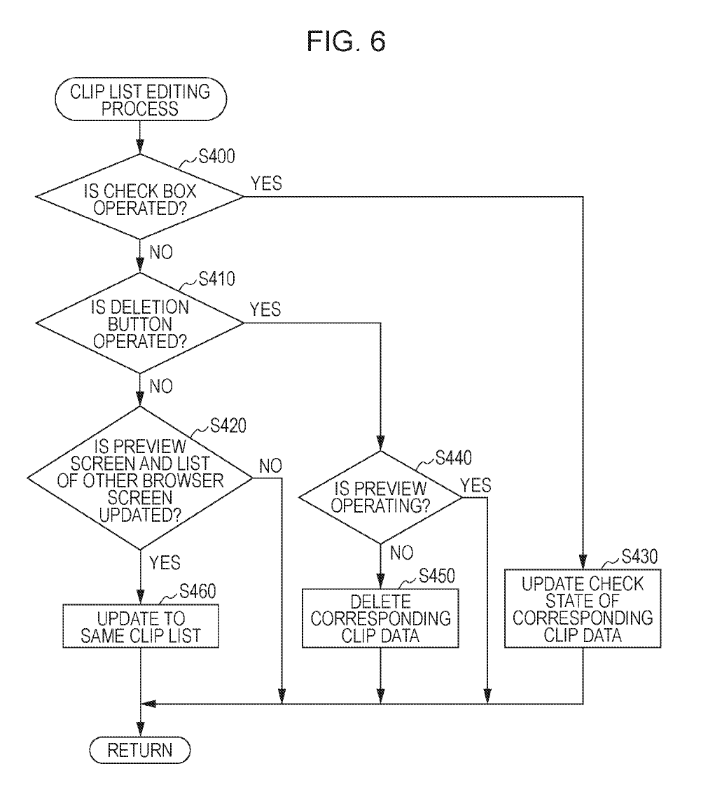

The process of Step S200 is performed by performing the clip list editing process shown by way of example in FIG. 6. In the clip list editing process, it is determined whether or not the check box operation, that is, one of the check boxes or the all-check-on button 74 and the all-check-off button 75 is left-clicked (Step S400), whether or not the operation of the deletion button, that is, one of the all-deletion button 76 and the check item deletion button 77 is left-clicked (Step S410), and whether or not one of the clip list of the operating browser screen other than the browser screen 50 and the clip list of the printing preview screen to be described later is updated (Step S420). When all determination is negative, nothing is performed, and the process is ended. When the check box operation is performed, the check state of the clip data is updated according to the left-clicked button (Step S430). When the operation of the deletion button is performed, it is determined whether or not the printing preview screen is operating (Step S440). When the printing preview screen is not operating, the clip data is deleted according to the left-clicked button (Step S450). When the printing preview screen is operating, the clip data is not deleted. When one of the clip list of the operating browser screen other than the browser screen 50 and the clip list of the printing preview screen is updated, the clip list is updated to the same clip list, synchronizing with the updating (Step S460). When the browser screen 50 and the printing preview screen are operated as individual processes, independent virtual address spaces are provided. Accordingly, the process may be performed by transmitting and receiving the clip list using one inter-process communication of a function supported by, for example, an OS.

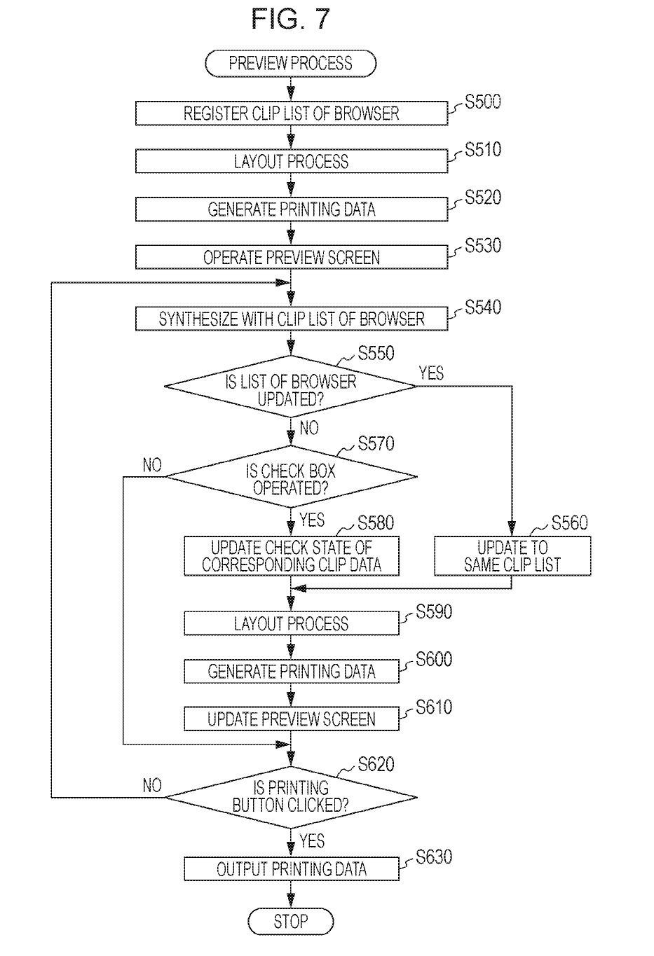

Next, the preview process will be described. FIG. 7 is a flowchart illustrating an example of the preview process performed by the CPU 32 of the information processing device 20 of the embodiment. In the example of the clip printing, the process is performed when one of the printing/preview button 78 of the operating browser screen 50 and the selection range printing button 82 is left-clicked and the operation of the printing preview screen is instructed.

When the preview process is performed, the CPU 32 first registers the same clip list as the clip list of the browser screen instructed to operate the printing preview screen, as the clip list of the printing preview screen (Step S500). As described above, the process may be performed by transmitting and receiving the clip data using the inter-process communication. Subsequently, a process of reading the clip data set to the check-on from the clip data of the registered clip list and laying out the clip data in the preview sheet area is performed (Step S510). The layout process is performed according to the following layout rule.

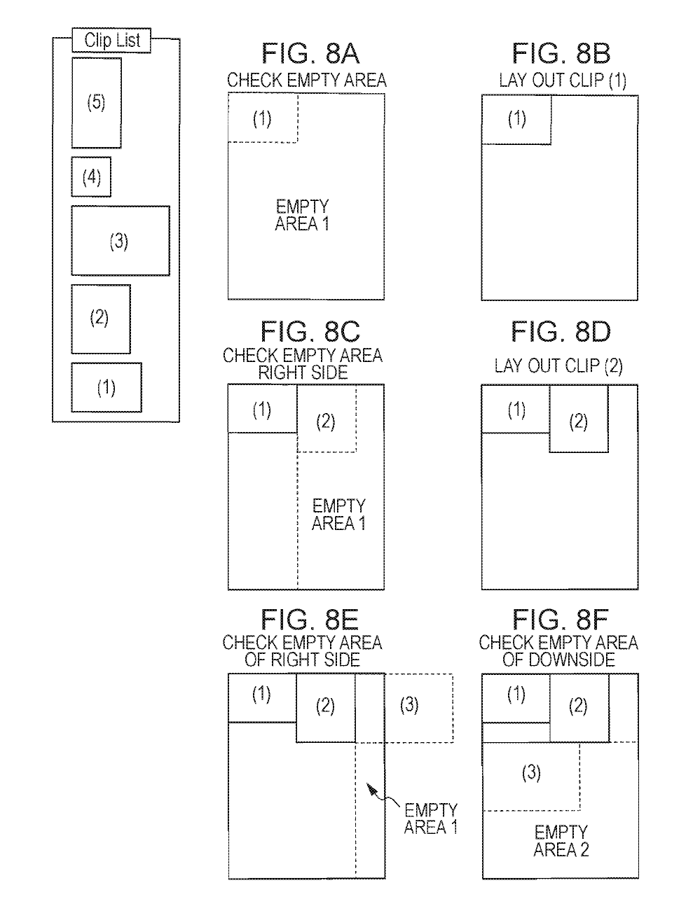

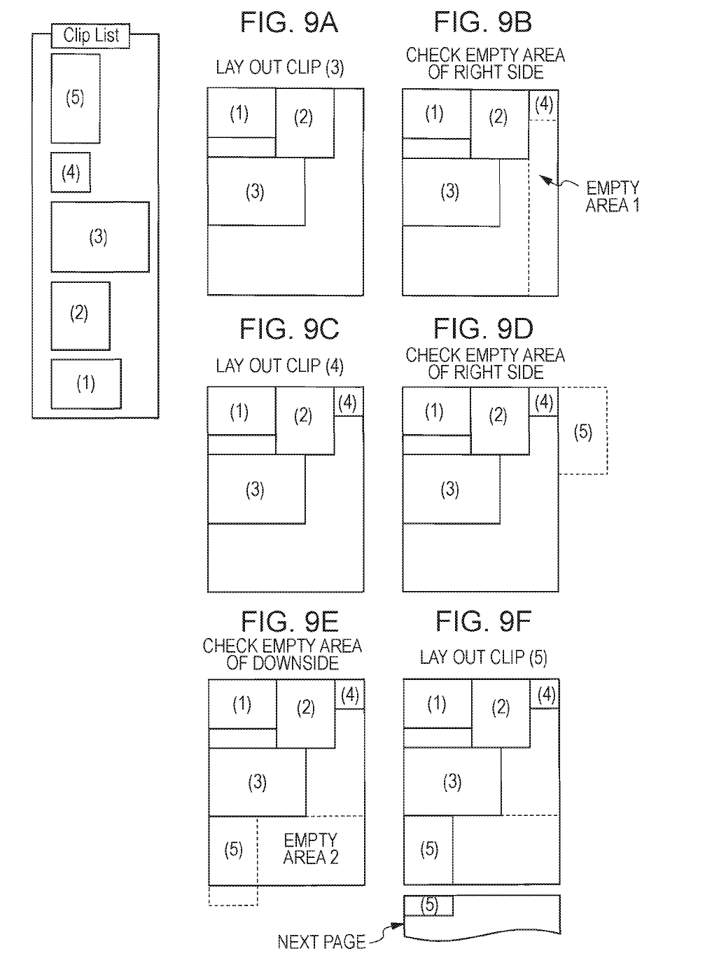

FIG. 8A to FIG. 8F show the first half portion of laying out five clip data 1 to 5 in the sheet area, and FIG. 9A to FIG. 9F show the second half portion. In the layout process, first, the clip data 1 to 5 of the check-on of the clip data registered in the clip list are arranged in order of old registration. Subsequently, an empty area of the sheet area is checked, it is determined whether or not the oldest registered clip data 1 fits into the empty area (see FIG. 8A). Since the whole sheet area is the empty area at the first time, the clip data is provided on the left upper side of the empty area (see FIG. 8B). Subsequently, the empty area 1 of the right side in the sheet area after the clip data 1 is provided is checked, it is determined whether or not the width of the next clip data 2 fits into the empty area 1 (see FIG. 8C). Herein, the empty area 1 comes into contact with the right side of the laid-out clip data, and represents a rectangular area where the printing area is empty in the horizontal direction. Since the width of the clip data 2 fits into the empty area 1, the clip data 2 is provided on the left upper side of the empty area 1 (see FIG. 8D). The empty area 1 of the right side in the sheet area after the clip data 1 and 2 are provided is checked, it is determined whether or not the width of the next clip data 3 fits into the empty area 1 (see FIG. 8E). Since the width of the clip data 3 exceeds the empty area 1 of the right side, the empty area 2 of the downside is further checked, and it is determined whether or not the height of the clip data 3 fits into the empty area 2 (see FIG. 8F). Herein, the empty area 2 comes into contact with the lower end of the laid-out clip data, and represents a rectangular area where the printing area is empty in the vertical direction. Since the height of the clip data fits into the empty area 2, the clip data 3 is provided on the left upper side of the empty area 2 (see FIG. 9A). Then, the empty area 1 of the right side in the sheet area after the clip data 1 to 3 are provided is checked, and it is determined whether or not the width of the next clip data 4 fits into the empty area 1 (see FIG. 9B). Since the width of the clip data 4 fits into the empty area 1, the clip data 4 is provided on the left upper side of the empty area 1 (see FIG. 9C). Then, the empty area 1 of the right side in the sheet area after the clip data 1 to 4 are provided is checked, and it is determined whether or not the width of the clip data 5 fits into the empty area 1 (see FIG. 9D). Since the width of the clip data 5 exceeds the empty area 1, the empty area 2 of the downside is further checked, and it is determined whether or not the height of the clip data 5 fits into the empty area 2 (see FIG. 9E). Since the height of the clip data 5 exceeds the empty area 2, the part which does not exceed the empty area 2 of the clip data 5 is provided in the empty area 2, and the exceeding part is provided on the left upper side of the sheet area of the next page (see FIG. 9F). As described above, in the layout process, when the clip data can be provided in both of the empty area 1 of the right side and the empty area 2 of the downside, the empty area 1 is selected and provided. When the clip data can be provided in any one of the empty area 1 and the empty area 2, the clip data is provided in the empty area where the clip data can be provided. When the clip data cannot be provided in any of the empty area 1 and the empty area 2, the part where the clip data does not exceed the empty area 2 is provided in the empty area 2, and the exceeding part is provided in the sheet area of the next page.

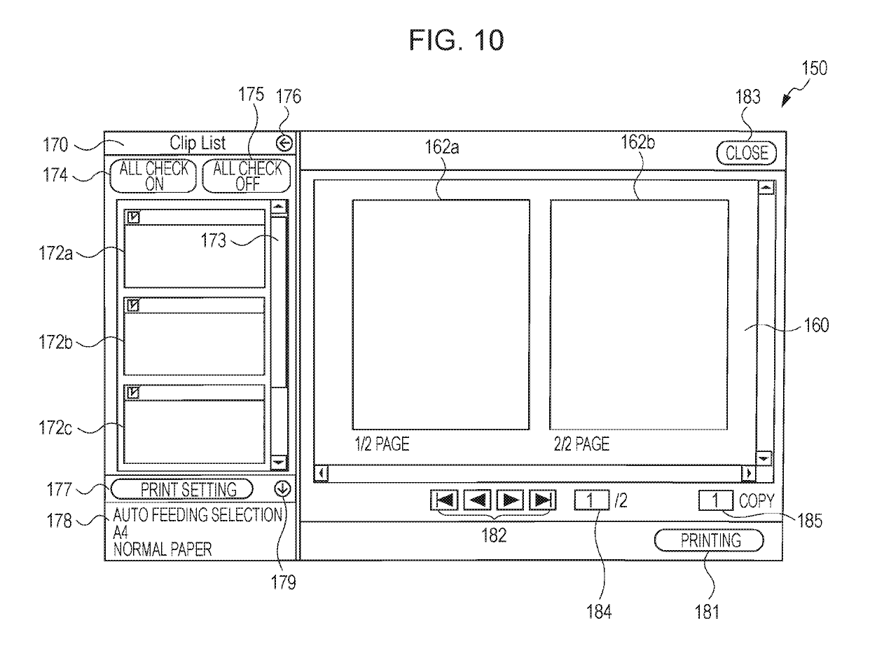

When the clip data is laid out in such a manner, the printing data is generated from the layout result (Step S520), and the printing preview screen on which the clip data is laid out in the preview sheet area is operated (Step S530). An example of the printing preview screen is shown in FIG. 10.

As shown in FIG. 10, on the printing preview screen 150, a preview display area 160 of displaying preview sheet areas 162a and 162b in which the clip data is laid out by a unit of 2 pages, a clip list display area 170 of displaying the clip data by thumbnails, a print setting display area 177 of displaying a printing setting, various buttons 181 to 183 for performing various operations of preview or printing, and various input boxes 184 and 185 capable of inputting various values are displayed. As the various buttons, a printing button 181 for printing the contents of the preview sheet areas 162a and 162b with the current print setting, a page pass button 182 formed of a leading page button of displaying a leading page of the preview sheet, a pre-page button of displaying a previous page, a next page button of displaying the next page, and a last page button of displaying the last page, and a close button 183 for closing the printing preview screen 150 are provided. As the various input boxes, a tendency page display/input box 184 capable of displaying a page number of the current displayed page with respect to a total page number and inputting a page number for changing display, and a printing copy number designating box 185 designating the number of printing copies are provided. In the clip list display area 170, thumbnail images 172a to 172c obtained by forming the clip data into thumbnails, and various buttons 174 to 176 for performing various operations on the clip data are displayed. On the right side of the thumbnail images 172a to 172c, a scroll bar 173 for displaying the thumbnail images which cannot completely get into the clip list display area 170 by longitudinal scroll is provided. Check boxes provided on the left upper side of the thumbnail images 172a to 172c are provided to select printing clip data. When the check box is left-clicked with the cursor by the mouse 26 in a check-off state, the check is turned on. When the check box is left-clicked with the cursor by the mouse 26 in the check-on state, the check is turned off. As the various buttons provided in the clip display area 170, an all-check-on button 174 of checking-on the check boxes of all the clip data in the clip list, an all-check-off button 175 of checking-off the check boxes of all the clip data in the clip list, and a list storing button 176 of closing the clip list display area 170 are provided. In the print setting display area 177, a print setting confirmation list 178 of displaying a currently set paper feeding manner, a paper size, a paper type, and the like, and a list storing button 179 of closing the print setting display area 177 are displayed. In addition, the list storing buttons 176 and 179 become list restoring buttons for returning to the state where the list is displayed, in the state where the list is closed.

When the printing preview screen 150 is operated, it is synchronized with the clip list of the operating browser screen (Step S540), it is determined whether or not the clip list of the browser screen is updated (Step S550). When the clip list is updated, it is updated to the same clip list as the clip list of the browser screen (Step S560). When the plurality of browser screens are operated, the browser screen 50 of the parent screen of operating the printing preview screen 150 waits in the modal state, as described in Step S350 of the clip mode process shown in FIG. 4. Accordingly, no operation is received from the user, but the browser screen other than the parent screen is independent from the printing preview screen 150, and thus various operations are possible. Accordingly, when the clip data is added from the browser screen 50 other than the parent screen or the check state from the clip data is updated, the process of Steps S540 to S560 becomes a process of reflecting this to the clip list of the printing preview screen 150. In addition, as described above, the synchronization process may be performed by transmitting and receiving the clip list using the inter-process communication. When the clip list is updated, the layout process is performed on the basis of the updated clip list (Step S590), the printing data is generated (Step S600), and the printing preview screen 150 is updated on the generated printing data (Step S610).

When it is determined that the clip list of the browser screen is not updated in Step S550, it is determined whether or not the check box operation of the clip list display area 170 of the printing preview screen 150, that is, one of each check box, an all-check-on button 174, and an all-check-off button 175 is left-clicked (Step S570). When the operation of the check box operation is performed, the check state of the clip data is changed according to the kind of the left-clicked button to update the clip list (Step S580), the layout process is performed on the basis of the updated clip list, the printing data is generated, and the printing preview screen 150 is updated (Steps S590 to S610). Meanwhile, when the check box operation is not performed, the process proceeds to the next process without updating the printing preview screen 150. When the check state of the clip data is updated with the printing preview screen 150, the process of Steps S570 and S580 becomes a process of reflecting to the clip list of the printing preview screen 150.

Until the printing button 181 is left-clicked (Step S620), the process returns to Step S540 and the processes of Steps S540 to S610 are repeated. When the printing button 181 is left-clicked, the printing data is output to the printer 40 (Step S630), the preview process is ended.

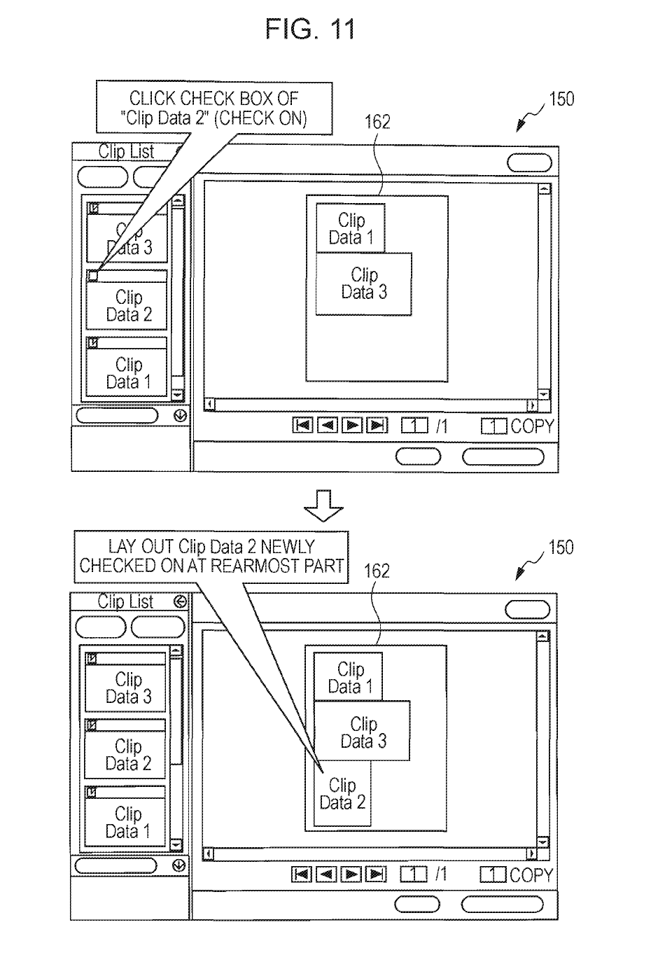

FIG. 11 shows the update of the preview display of the printing preview screen 150 by the check-on of the clip data. It is assumed that three sets of clip data of “Clip Data 1”, “Clip Data 2”, and “Clip Data 3” are registered in the clip list, “Clip Data 1” and “Clip Data 3” are checked on, and “Clip Data 2” is checked off. In this case, “Clip Data 1” and “Clip Data 3” are provided in the preview sheet area 162 according to the layout rule described above. In this state, when “Clip Data 2” is checked on, “Clip Data 2” is provided in the empty area of the preview sheet area 162 according to the layout rule described above, which can be arranged at the rearmost part with respect to “Clip Data 1” and “Clip Data 3” (can be arranged as the latest data). As described above, in the preview process shown in FIG. 7, the update or the layout process of the clip list, and the update of the printing preview screen 150 based thereon are repeatedly performed, and thus the check-on operation on the clip data is immediately reflected to the layout of the clip data in the preview sheet area 162. Since it is synchronized with the clip list of the operating browser screen, the check-on operation performed on the clip data in the clip list display area 170 on the browser screen 50 is also immediately reflected to the layout of the clip data in the preview sheet area 162.

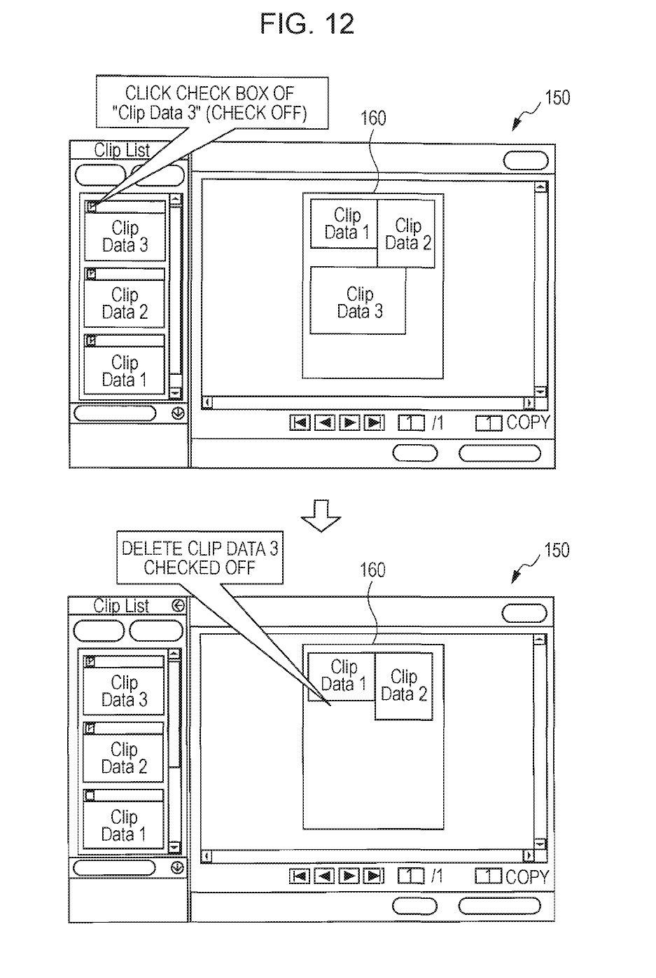

FIG. 12 shows the update of the preview display of the printing preview screen 150 by the check-off of the clip data. It is assumed that three sets of clip data of “Clip Data 1”, “Clip Data 2”, and “Clip Data 3” are registered as check-on. In this case, “Clip Data 1”, “Clip Data 2”, and “Clip Data 3” are provided in the preview sheet area 162 according to the layout rule described above. In this state, when “Clip Data 3” is checked off, only “Clip Data 3” is removed from the preview sheet area 162. As described above, in the preview process shown in FIG. 7, the update or the layout process of the clip list, and the update of the printing preview screen 150 based thereon are repeatedly performed, and thus the check-off operation on the clip data is immediately reflected to the layout of the clip data in the preview sheet area 162. Since it is synchronized with the clip list of the operating browser screen, the check-off operation performed on the clip data in the clip list display area 170 on the browser screen 50 is also immediately reflected to the layout of the clip data in the preview sheet area 162.

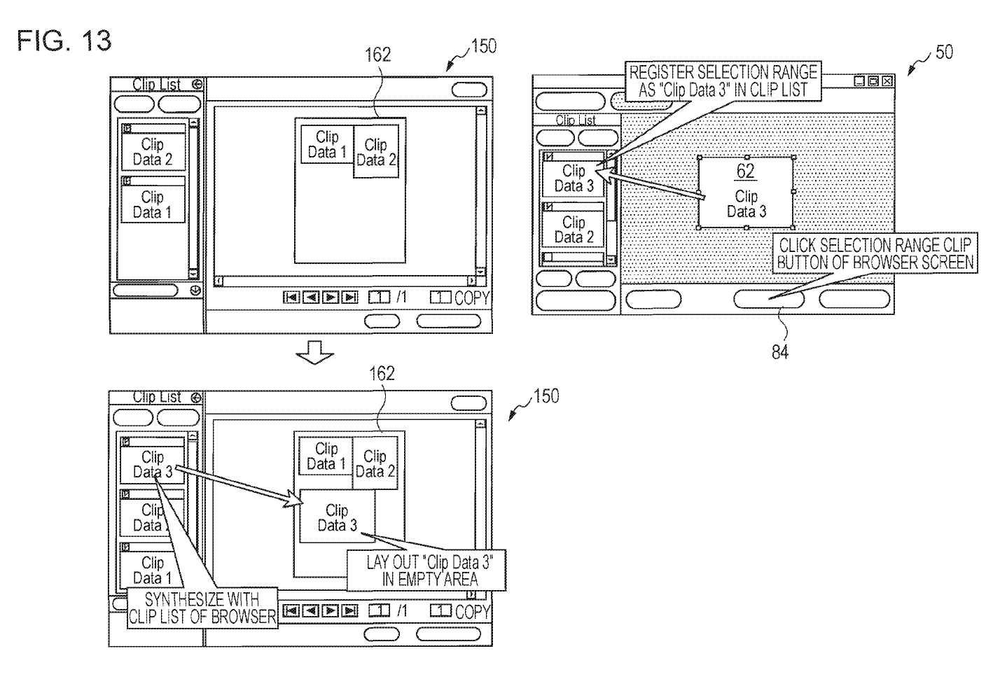

FIG. 13 shows the update of the preview display of the printing preview screen 150 by the addition of the clip data on the browser screen 50 in the state where the printing preview screen 150 is operated. It is assumed that two sets of clip data of “Clip Data 1” and “Clip Data 2” are registered, and “Clip Data 1” and “Clip Data 2” are checked on. In this case, “Clip Data 1” and “Clip Data 2” are provided in the preview sheet area 162 according to the layout rule described above. In this state, when the browser screen other than the browser screen 50 that is the parent screen of operating the printing preview screen 150 is newly operated, the clip area 62 is selected for the webpage of the browser screen, and the selection button clip button 84 is left-clicked, the newly clipped content is registered as “Clip Data 3” in the clip list. At this time, the newly added “Clip Data 3” is provided in the empty area of the preview sheet area 162, on the printing preview screen 150. In the preview process shown in FIG. 7, the update or the layout process of the clip list, and the update of the printing preview screen 150 based thereon are repeatedly performed while synchronizing with the clip list of the operating browser screen, and thus the newly clipped content is immediately reflected to the layout of the preview sheet area 162. Accordingly, a troublesome operation of closing the printing preview screen 150 once, clipping the printing preview screen 150 with the browser screen 50, adding the clip data, and then re-operating the printing preview screen 150, to add the clip data, is not necessary.

Herein, correspondence between the constituent elements of the embodiment and the constituent element of the invention will be cleared up. The CPU 32 or the mouse 26 performing Steps S210 and S220 of the clip process shown in FIG. 5 of resizing or moving the clip band 61 for selecting the area of clipping the web page on the browser screen 50 corresponds to the “area designating unit”, the CPU 32 performing Steps S270 and S310 of clipping the selected area and generating the clip data corresponds to the “clip unit”, the CPU 32 performing the process of Steps S280 and S320 of registering the clip data in the clip list and the process of Step S500 of the preview process shown in FIG. 7 corresponds to the “clip list registering unit”, the CPU 32 performing the process of Steps S510 to Step S530 of operating the printing preview screen 150 of laying out the clip data in the preview sheet area corresponds to the “layout screen operating unit”, and the CPU 32 performing the process of Steps S540 to S610 of laying out the clip data updated synchronizing with the clip list of the operating browser screen 50 in the preview sheet area corresponds to the “layout screen updating unit”. In addition, the list display areas 70 and 170 correspond to the “list display unit”, and the CPU 32 and the mouse 26 performing the process of Steps S400 and S430 of the clip list editing process shown in FIG. 6 and the process of Steps S570 and S580 of the preview process shown in FIG. 7 correspond to the “clip information selecting unit”. In the embodiment, the operation of the information processing device 20 is described to clear an example of the information processing method and the program of the invention.

According to the information processing device 20 of the embodiment described above, when the clip of the arbitrary area is received in the web page on the browser screen 50 and is registered in the clip list and the operation of the printing preview screen 150 is instructed from the browser screen 50, the clip list of the browser screen 50 is registered as the clip list of the printing preview screen 150 and the printing preview screen 150 on which the clip data of the registered clip list is laid out in the preview sheet area is operated. When the clipping is newly performed on the web page on the browser screen other than the browser screen 50 (parent screen) of operating the printing preview screen 150 during the operation of the printing preview screen 150, the synchronization with the clip list of the browser screen and the layout of the clip data of the clip list are performed to update the printing preview screen 150. Accordingly, it is possible to immediately reflect the content newly clipped on the browser screen to the layout of the preview sheet area of the printing preview screen 150. As a result, a troublesome operation of closing the printing preview screen 150 once, clipping the printing preview screen 150 with the browser screen 50, adding the clip data, and then re-operating the printing preview screen 150, to add the clip data, is not necessary.

According to the information processing device 20 of the embodiment, the operation of the check-on and the check-off is received in the clip data of the clip list display area 170 of the printing preview screen 150, the update of the clip list and the layout process, the update of the printing preview screen 150 based thereon are repeatedly performed. Accordingly, it is possible to immediately reflect the operation of the check-on and the check-off of the clip data to the layout of the preview sheet area. In addition, since the clip list is updated synchronizing with the clip list of the operating browser screen 50, it is possible to also immediately reflect the operation of the check-on and the check-off performed on the clip data of the clip list display area 70 on the browser screen 50 to the layout of the preview sheet area 162 of the printing preview screen 150.

In the embodiment described above, when the printing preview screen 150 is clipped from the browser screen other than the browser screen (parent screen) of operating the preview screen 150 in the modal state during the operation of the plurality of browser screens 50, the clipped content is reflected to the layout of the preview sheet area of the printing preview screen 150 by the synchronization of the clip list. However, the printing preview screen 150 may be operated as a modeless state from the parent screen or the content clipped by receiving the clip operation from the browser screen of operating the printing preview screen 150 may be reflected to the layout of the preview sheet area of the printing preview screen 150.

In the embodiment described above, the clip data in the clip list is stored as it is even when all the browser screens 50 are ended. However, when all the browser screens 50 are ended, the clip data in the clip list may be deleted.

In the embodiment described above, the information processing device 20 of the invention is connected to the printer 40, and the content clipped on the browser screen 50 is display as the printing preview screen 150 for printing. However, the layout screen on which the clipped content is laid out is not limited to the displaying as the printing preview screen. In this case, it is not necessary to connect the information processing device 20 to the printer 40.

In the embodiment described above, the invention is described as the aspect of the information processing device 20, but may be an aspect of the information processing method. In addition, the invention may be an aspect of the program for realizing the information processing device 20 on a computer.

In addition, the invention is not limited to the embodiment described above, and it is natural that the invention is performed as various types within the technical scope of the invention.

What is claimed is:

1. An information processing device which processes page information displayed on a browser screen, the device comprising:
an area designating unit that designates an arbitrary area of a page displayed on the browser screen;
a clip unit that clips the designated area to generate clip information;
a clip list registering unit that registers the clip information generated by the clip unit, in a clip list;
a layout screen operating unit that operates a layout screen on which the clip information registered in the clip list is laid out when the layout screen is instructed to operate; and
a layout screen updating unit that lays out the updated clip information to update the layout screen, when the clip information registered in the clip list is updated during the operation of the layout screen.

2. The information processing device according to claim 1, wherein a plurality of browser screens are operable, one browser screen is operable as a parent screen, and the layout screen is operable as a child screen, and
wherein when the area designated from a browser screen different from a browser screen operating the layout screen among the plurality of operated browser screens is clipped during the operation of the layout screen and the clip information is generated, the clip list registering unit registers the generated clip information in the clip list.

3. The information processing device according to claim 1, further comprising:
a list display unit that displays the clip information registered in the clip list as a thumbnail picture; and
a clip information selecting unit that selects arbitrary clip information from the clip information registered in the clip list on the basis of an operation of a user,
wherein the layout screen operating unit and the layout screen updating unit lay out the clip information selected by the clip information selecting unit from the clip information registered in the clip list and display the clip information on the layout screen.

4. The information processing device according to claim 3, wherein when all processes of the plurality of operated browser screens are completed, the clip list registering unit clears the selection of the clip information registered in the clip list.

5. The information processing device according to claim 1 connected to the printing device, wherein the layout screen is a printing preview screen.

6. A recording medium storing a program for causing a computer to function as an information processing device which processes page information displayed on a browser screen, the program comprising:
an area designating module that designates an arbitrary area of a page displayed on the browser screen;
a clip module that clips the designated area to generate clip information;
a clip list registering module that registers the generated clip information in a clip list;
a layout screen operating module that operates a layout screen on which the clip information registered in the clip list is laid out when the layout screen is instructed to operate; and
a layout screen updating module that lays out the updated clip information to update the layout screen, when the clip information registered in the clip list is updated during the operation of the layout screen.

7. An information processing method of processing page information displayed on a browser screen, the method comprising:
designating an arbitrary area of a page displayed on the browser screen;
clipping the designated area to generate clip information;
registering the generated clip information in a clip list;
operating a layout screen on which the clip information registered in the clip list is laid out when the layout screen is instructed to operate; and
laying out the updated clip information to update the layout screen, when the clip information registered in the clip list is updated during the operation of the layout screen.
